(19) United States
(12) Patent Application Publication
(10) Pub. No.: US 2026/0057799 A1
(43) Pub. Date: Feb. 26, 2026

(54) MONITOR DISPLAY STAND

(71) Applicant: VESARO LIMITED, Hertfordshire (GB)

(72) Inventor: Nevil Slade, Hertfordshire (GB)

(73) Assignee: Vesaro Limited, Hertfordshire, EN (GB)

(21) Appl. No.: 19/103,226

(22) PCT Filed: Sep. 25, 2023
(86) PCT No.: PCT/GB2023/052474

§ 371 Date: Feb. 11, 2025

(30) Foreign Application Priority Data
Sep. 23, 2022 (GB) 2213910.9

(51) Int. Cl. G09B 9/02; F16M 11/22

(52) U.S. Cl. CPC G09B 9/02; F16M 11/22

(57) ABSTRACT

A monitor display stand for use with a vehicle simulator has a main body including a seat and with the monitor display stand having a base for location below the main body. A monitor support structure is mounted on the base and for extension within the main body to a position located above the main body. The support structure is adapted to support at least one monitor above the main body, so that the main body can move independently of the monitor display stand. A vehicle simulator having a vehicle body and a monitor display stand of the invention is also provided.

### FIELD OF THE INVENTION

This invention relates to monitor display stands and particularly to such stands for use with vehicle simulators.

### BACKGROUND TO THE INVENTION

Vehicle simulators are known which have separate monitor display stands.

### STATEMENTS OF THE INVENTION

According to the present invention there is provided a monitor display stand for use with a vehicle simulator having a main body including a seat, the monitor display stand comprising a base for location below said main body, a monitor support structure mounted on said base and for extension within said body to a position located above said body, said support structure being adapted to support at least one monitor above said body, whereby the main body can move independently of the monitor display stand.

Preferably, the monitor display stand is arranged to remain static while the main body moves. More preferably, the extent of movement of the main body relative to the monitor display stand is several centimetres, preferably from 3.5 to 15 cms.

Preferably, the monitor display stand is a cantilevered arrangement. More preferably, the monitor display stand comprises an elongate base and a cantilevered arm extends within the main body and is connected to a monitor support column which extends above said main body.

Preferably, there is a gap between the main body and the monitor display stand at the lower edge of the main body and a flexible barrier is mounted in the gap.

Preferably. The monitor support column extends through a hole in the main body providing a gap therebetween. More preferably, a flexible barrier is mounted in this gap.

The present invention also provides a vehicle simulator comprising a vehicle body and a monitor display stand according to the invention.

### BRIEF DESCRIPTION OF THE DRAWINGS

The accompanying drawings are as follows:

FIG. 1 is a perspective view on the rear and one side of a vehicle simulator having a monitor display stand in accordance with the invention;

FIG. 2 is a perspective view on the rear and one side of the monitor display stand shown in FIG. 1;

FIG. 3 is a perspective view on the front and one side of the monitor display stand shown in FIG. 1;

FIG. 4 is a perspective view on the front and one side of the vehicle simulator of FIG. 1;

FIG. 5 is a perspective view on the front and one side of the vehicle simulator of FIG. 1 with the main body of the simulator set to 80% opacity;

FIG. 6 is left side view of the vehicle simulator of FIG. 1 with the main body of the simulator being greyed out;

FIG. 7 shows the multiple axes though which the main body of the simulator moves; and

FIG. 8 illustrates the various motions carried out by the simulator under control of software.

### DETAILED DESCRIPTION OF THE INVENTION

The invention will now be described, by way of example only, with reference to the accompanying drawings.

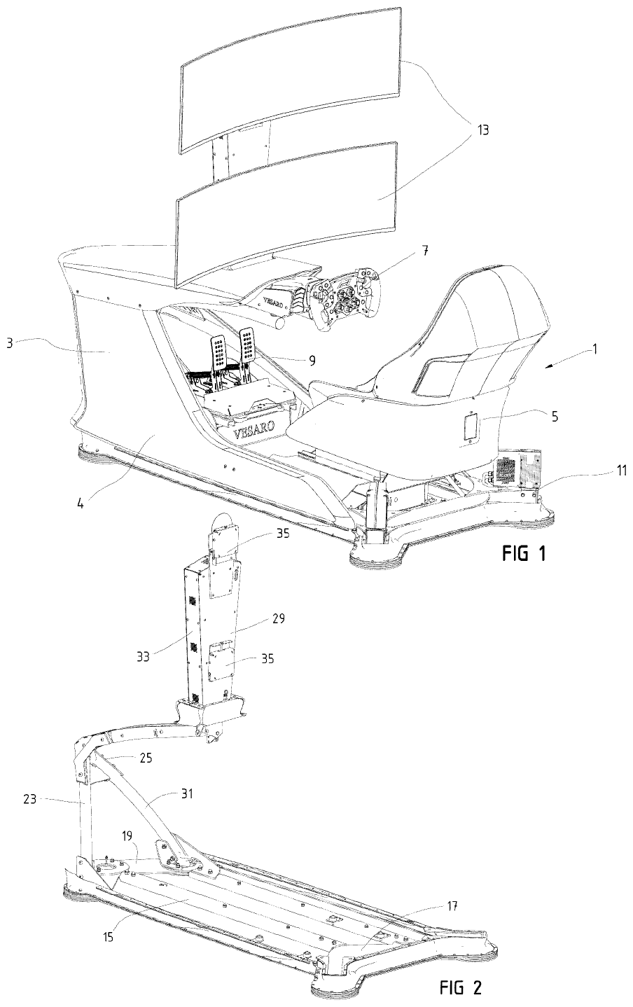

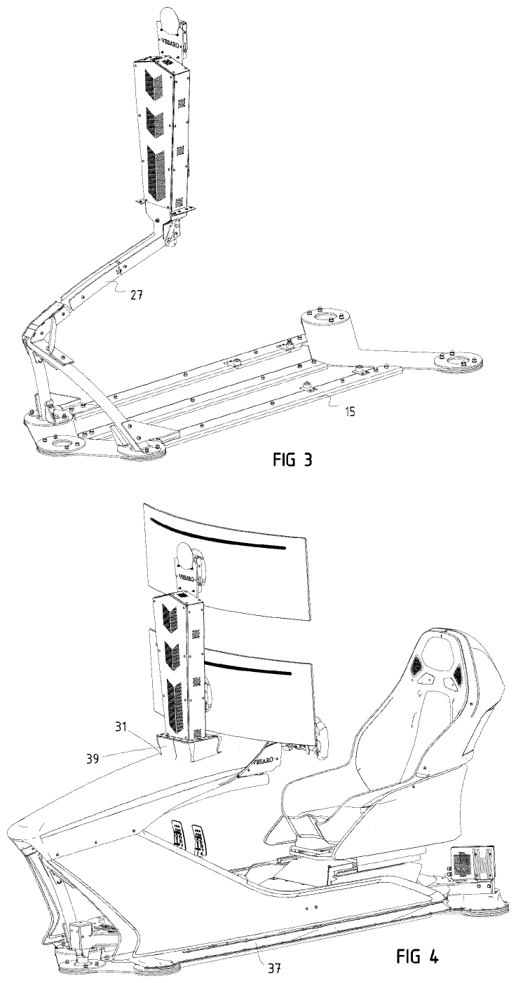

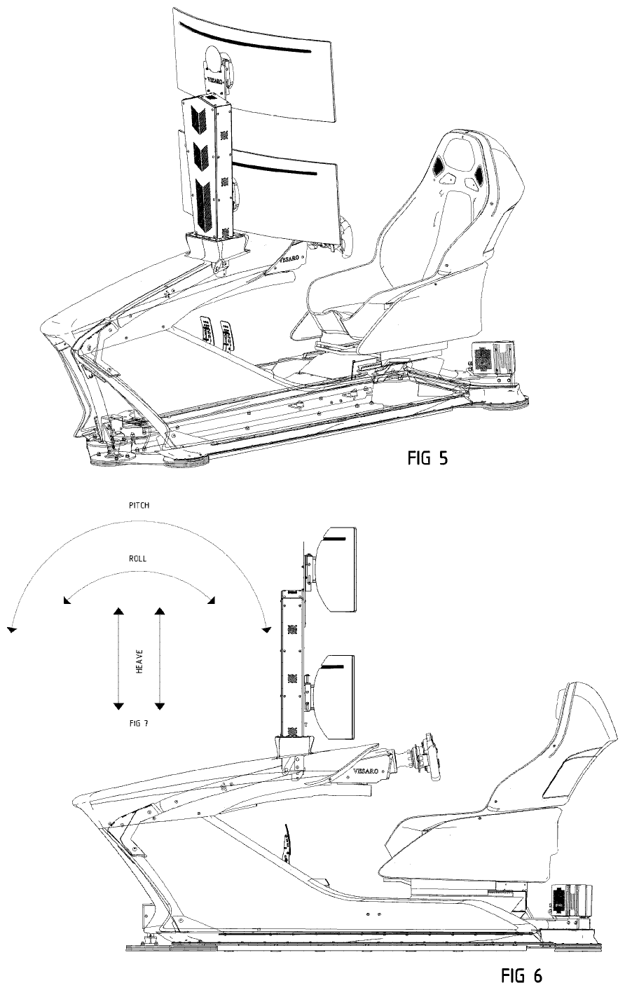

Referring to FIG. 1 of the accompanying drawings, a vehicle simulator 1 has a main body 3 which includes a body housing 4, a seat 5, a steering wheel 7 and foot controls 9. Main body 3 sits on a monitor display stand 11 which supports a pair of monitors 13. The display stand 11 appears to be part of the main body 3 but is in fact a separate structure which is not in contact with any part of the main body 3 and appears to float, remaining static when the main body 3 is moving. Referring to FIGS. 2 and 3 of the accompanying drawings, the display stand 11 comprises a base 15 having three parallel bars connected at each end by flat angle bar elements 17, 19.

Extending upwardly from the front end of base 15 of display stand 11 are struts 21, 23 which are angled with respect to the vertical and which meet at bracket 25 which lies above the front end of base 15.

Bracket 25 is a gently curved arm 27 which extends rearwardly from bracket 25 so that it overlies base 15 over about two fifths of its length. Column 29 extends upwardly from that end of arm 27 which is remote from bracket 25.

Apart from column 29, the monitor display stand lies wholly within the housing 4 of main body 3. Column 29 extends through a hole 31 in the housing 4 and carries a computer 33. The monitors 13 are mounted directly to the housing of the PC or to brackets 35 attached to the PC housing, thereby providing varying height capability. The cantilever weight loaded design of the monitor display stand allows the monitor to be positioned close to seating position by using a base 15 which positions the centre of gravity past the monitors thereby avoiding the structure toppling over. The base 15 also provides a platform for the main body of the simulator to sit on by effectively clamping the display stand to the floor by utilising the weight of the main body.

The main body 3 of simulator 1 is provided with motion actuators which sit inside cups that form part of the display stand 11. There are two cups in each rear corner and one in the front centre.

This arrangement constrains the movement of the main body 3. Typically the extent of movement in each direction is from 3.5 to 15 cms.

In an alternative arrangement, separate cups are provided on the floor rather than on the display stand.

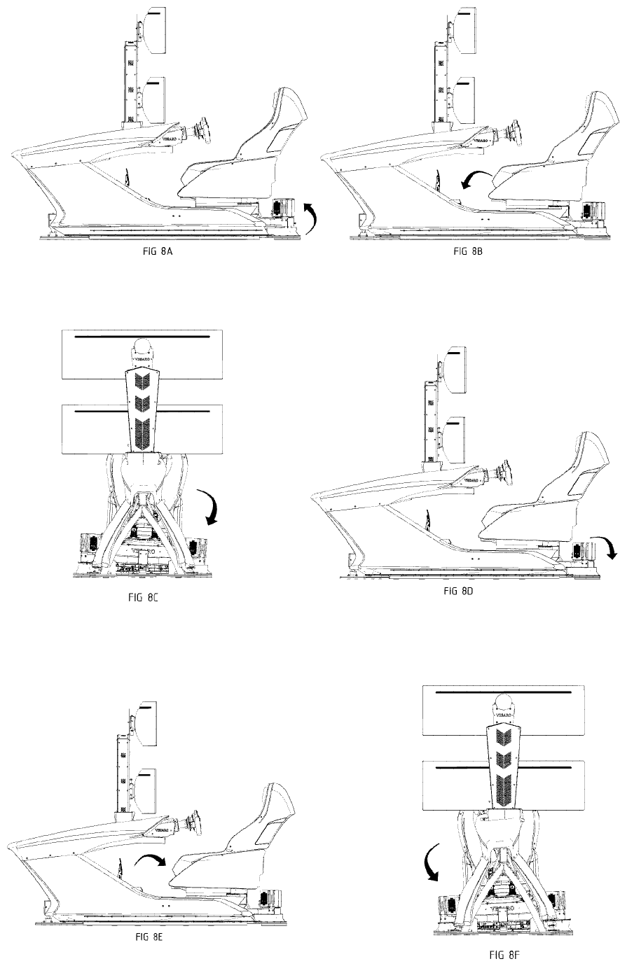

The vehicle simulator 1 uses motion technology to move in multiple axes of pitch, roll and heave, these motions being controlled by software and being illustrated in FIGS. 7 and 8A to 8F.

The main body 3 of vehicle simulator 1 is provided at its lower edge with a flexible barrier 37 which prevents body parts or objects being inserted into the gap between main body 3 and the base 15. A further flexible barrier 39 provides the same function for the hole 31 through which column 29 passes.

In summary, monitor display stand of the invention holds one or more monitors, orienting them in the correct position relative to the seated user of the simulator. It is in effect an invisible structure as the framework is hidden inside the outer body of the simulator. It provides a separate functionality to that of the simulator by not being in contact with any part of the main simulator body.

The main simulator body uses motion technology to move in multiple axes of pitch, roll and heave.

The display stand appears to be part of the main body but is actually separate with the main vertical column passing through a hole in the top of the main body shell. It therefore remains static when the main body of the simulator moves around it and the motion is active.

The cantilever weight loaded design allows the monitors to be positioned close to the seating position with long extending poles that would ordinarily just topple over. This is avoided because the base extends the centre of gravity past the monitors.

1-9. (canceled)

10. A vehicle simulator comprising a vehicle body including a seat and a monitor display stand, said monitor display stand comprising an elongate base for location below said main body, a monitor support structure mounted on said base and comprising a cantilevered arm extending within said main body and connected to a monitor support column which extends to a position above said main body, said support structure being adapted to support at least one monitor above said main body, so that said main body can move independently of the monitor display stand.

11. The vehicle simulator according to claim 10, wherein the monitor display stand remains static while said main body has movement.

12. The vehicle simulator according to claim 11, wherein the movement of said main body relative to said monitor display stand is from 3.5 to 15 cm.

13. The vehicle simulator according to claim 10, wherein there is a gap between said main body and said monitor display stand at a lower edge of said main body, and a flexible barrier is mounted in the gap.

14. The vehicle simulator according to claim 10, wherein the monitor support column extends through a hole in said main body providing a gap therebetween.

15. The vehicle simulator according to claim 14, wherein a flexible barrier is mounted in the gap between the hole and said main body.
